(19) United States
(12) Patent Application Publication
(10) Pub. No.: US 2017/0305674 A1
(43) Pub. Date: Oct. 26, 2017

(54) TRAYS CONVEYOR WITH PUSHER ARMS DISCHARGING OBJECTS

(71) Applicant: OPTIMUS SORTER HOLDING B.V., Wijchen (NL)

(72) Inventor: Jacobus Johannes Adrianus DEBRUIJN, Wijchen (NL)

(73) Assignee: OPTIMUS SORTER HOLDING B.V., Wijchen (NL)

(21) Appl. No.: 15/517,751

(22) PCT Filed: Oct. 8, 2015
(86) PCT No.: PCT/NL2015/050709

§ 371 Date: Apr. 7, 2017

(30) Foreign Application Priority Data
Oct. 9, 2014 (NL) 2013604

(51) Int. Cl. B65G 17/22; B65G 47/84; B65G 47/96; B65G 17/34

(52) U.S. Cl. CPC B65G 17/22; B65G 47/96; B65G 47/844; B65G 17/34

(57) ABSTRACT

Device for loading, conveying and discharging of objects, which device is provided with: trays each intended for carrying an object from a loading position to a discharge position,—a pusher arm arranged on the tray for by means of pushing away, discharging an object present on the tray,—a drive system for conveying the trays in a conveyance direction from the loading position to the discharge position, wherein for the purpose of conveying the trays along a path, the drive system comprises a series of linked driving elements, and—a drive for driving the drive system, wherein, considered in the conveyance direction, a first tray precedes with respect to a subsequent second tray, wherein the first tray is fixedly connected with one of the driving elements, and wherein the second tray is fixedly connected to the driving element to which the first tray is connected.

The device relates to a device for loading, conveying and discharging objects, which device is provided with:

trays each intended for carrying an object from a loading position to a discharge position, in which discharge position the object leaves the tray via an unloading section of the tray,

a drive system for conveying the trays in a conveyance direction from the loading position to the discharge position, wherein for the purpose of conveying the trays along a path, the drive system comprises a series of linked driving elements,

a drive for transferring a drive power onto the drive system, which drive power is required for conveying the trays, and

a pusher arm arranged on the tray for by means of pushing away, discharging an object present on the tray, wherein pushing away takes place substantially transverse to the conveyance direction of the tray, and wherein at least during conveyance of an object present on the tray the pusher arm is in a first position facing away from the unloading section, and wherein at least for discharging an object present on the tray, the pusher arm moves to a second position in which the pusher arm is near the unloading section of the tray.

Such a device which is generally used for to the sorting of objects, is known in the art. The trays are movable via a guiding path, wherein the path extends substantially in the horizontal plane, so that the trays are transportable in a substantially horizontal plane. The trays are generally carried out as carriers having a substantially rectangular shape, which carriers are provided with a positioning surface on which an object to be conveyed and sorted can be placed. On each tray a push mechanism is mounted which is suitable for pushing away an object in a direction that is lateral relative to the conveyance direction, the object for this purpose having a weight which is roughly between 0.1 kg to 50 kg. Thus, it is the intention to sort with this sorting device packages such as, carton boxes, plastic boxes, trays and bags. Thereby it is advantageous to manufacture the trays with a length dimension extending parallel to the conveyance direction of at least 200 mm, preferably up to 600 mm, and with a width dimension extending transversely to the conveyance direction of at least 300 mm, preferably up to for example 800 mm.

The path to be passed through by the trays is in general an endless path. That is, the movable series of trays is movable during a continuous movement in the conveyance direction sequentially along a same, selected point of the path. The device is arranged such that an object can placed on a tray at a loading position along the path, and that at a discharge position along the path the object can be collected near the unloading section of the tray in, for example, a target container in which at least one object is sortable.

Known devices have the drawback that not all objects are suitable for processing and that there are restrictions with respect to a size and/or a shape and/or a weight of the object. The conveyance and sorting process can falter when an object placed on the tray is too big and thereby at least partially hangs over an edge of the tray and falls through a gap which extends in the conveyance direction before or behind the edge between the tray and a preceding respectively subsequent tray. Especially when the tray moves through the bend the likelihood of jerking movements as a result of the dynamic operation of the device increases, whereby also the likelihood is increased that an at least partially over the edge hanging object falls in the gap. An object placed on a tray can even hang over an edge to such an extent that the object at least partially rests on a preceding tray or subsequent tray and is supported thereby. When moving through a bend of the path it is thereby conceivable that a part of the object that is closest to the outside bend ends up in a further opened gap and, at least partially, falls through this. The descending motion of that part of the object is a high risk of a malfunction of the sorting process.

It is an object of the invention to provide a device which does not have this drawback and which, however, is suitable for the purpose of sorting, loading, conveying and discharging the objects described above.

This goal is achieved with a device for loading, conveying and discharging objects, which device is provided with:

trays each intended for carrying an object from a loading position to a discharge position, in which discharge position the object leaves the tray via an unloading section of the tray,

a drive system for conveying the trays in a conveyance direction from the loading position to the discharge position, wherein for the purpose of conveying the trays along a path, the drive system comprises a series of linked driving elements,

a drive for transferring a drive power onto the drive system, which drive power is required for conveying the trays, and

a pusher arm arranged on the tray for by means of pushing away, discharging an object present on the tray, wherein pushing away takes place substantially transverse to the conveyance direction of the tray, and wherein at least during conveyance of an object present on the tray the pusher arm is in a first position facing away from the unloading section, and wherein at least for discharging an object present on the tray, the pusher arm moves to a second position in which the pusher arm is near the unloading section of the tray,

wherein considered in the conveyance direction a first tray precedes a subsequent second tray, wherein the first tray is fixedly connected to one of the driving elements, and wherein the second tray is fixedly connected to the driving element to which the first tray is fixedly connected, wherein a slit extends between an edge of the first tray extending near the second tray and an edge of the second tray extending near the first tray, wherein a width dimension of the slit is selected such that the edges form a support system for supporting the circumferential wall of elongated objects with a cross-section of at least 12.5 mm during transportation. This enables a device that is provided with trays and pusher arms arranged on the trays to, with a movement of the trays, both on a straight part and on a bend, maintain a constant gap between the first tray and the second tray and to prevent the two trays from moving apart, whereby the risk that an object partially present on the first tray and partially present on the second tray can fall in the resulting gap between the first and second tray is substantially eliminated and a disturbance of the conveyance process, such as a halt of the sorting device, is substantially prevented. The edge of the first tray extending near the second tray and an edge of the second tray extending near the first tray, form a stable support system that enables an elongated object placed on the edges to be transported in a stable way by the device according to the invention during transportation, without the object, as a result of the dynamic operation of the device, falling or rolling of the tray or falling in the slit and the extending zone underneath it.

In one embodiment, the width dimension of the slit is in the range of 10-100 mm, preferably in the range of 15-50 mm, with even more preference in the range of 20-30 mm. As a result, it becomes possible to transport and sort elongated objects, such as aerosols, paint cans, and bottles, by means of the device, specifically objects with a width dimension of approximately 20 mm to about 60 mm and very specifically objects with a width dimension of approximately 25 mm to about 35 mm.

In one embodiment, the pusher arm of at least the first tray is provided with an end that reaches over the edge and reaches, at least partially, above the slit for the unloading, by means of pushing away, of an object that is present on the support system. As such, it becomes possible to, during operation, push an object that is placed at least partially above the slit and an object that is present on the support system, of the support system by a movement of the pushing arm from the first to the second position.

In one embodiment, a driving element, seen in a cross section oriented transversely to the conveyance direction, is substantially arranged in such a way with respect to the tray that a part of the tray facing away from the unloading section is situated between the unloading section of the tray and the driving element. As a result, the drive system is located laterally with respect to the path of the trays, whereby space is available underneath the path of the trays for other necessary components for the device.

In one embodiment, the device comprises a control system for controlling at least the drive for the drive system and for positioning an object to be sorted on a tray in the loading position, wherein the control system is adapted for determining a moment of placing an object of such dimensions that it has to be placed at least in part on the first tray, and at least in part on the second tray that is connected to the first tray via the driving element. As a result, a device becomes possible with which objects that are too large for support on a single first or second tray, can still be offered to the sorting device for sorting by a timed or a point in time based precise placement of the object at least partially on the first tray, which is connected to the driving element, and at least partially on the second tray, which is connected to the driving element to which is the first tray is fixedly connected, whereby the precise placing is, for example, selected such that the centre of gravity of the object lays approximately between the first and the second tray.

In one embodiment, the device comprises an exchange system placed underneath the path of the trays, for driving the pusher arm in order to push away an object present on the tray substantially transverse to the conveyance direction. As a result, it becomes possible to, with an exchange system that is controllable by means of a control system, move a pushing arm in such a manner above the placing surface of the tray that an object to be sorted which is placed on the placing surface can be pushed of the tray in a timely manner at a point in time determined by the control system, after which the object to be sorted ends up in a predetermined container or target container placed next to and underneath the path for further processing or distribution.

In one embodiment the exchange system comprises an actuator and the pusher arm arranged on the tray comprises a protrusion extending towards the exchange system, wherein the actuator, when operated, ends up in the path of the protrusion such that the actuator contacts the protrusion and urges the protrusion in a guiding part of the exchange system as a result of which the pusher arm moves into the second position. As a result, it becomes possible to control the pushing arm by means of an actuator from a first position to the second position.

In one embodiment, the control system is adapted for operating the actuator for a movement of the pusher arm of the first tray and for subsequent operation of the actuator for a movement of the pusher arm of the second tray. As a result, it becomes possible to discharge an object placed on the first tray before an object placed on a second tray which is connected through the same driving element.

In one embodiment, the control system is adapted for operating the actuator for a movement of the pusher arm of the first tray and for substantial simultaneous operation of the actuator for a movement of the pusher arm of the second tray. As a result, it becomes possible to discharge an object placed on the first tray substantially at the same time with an object placed on the second tray that is connected via the same driving element. Additionally, it becomes possible to process a larger and/or heavier object partially on both the first and second tray through the device, whereby, with the pushing away of the object, the pushing arm of the first and second tray can be substantially simultaneously driven for a movement from the first position to the second position.

In one embodiment, an edge of the first tray extending near the second tray is provided with a first upright edge section for guiding an object present on the first tray during discharge, and/or wherein an edge of the second tray extending near the first tray is provided with a second upright edge section for guiding an object present on the second tray during discharge. As a result, a device becomes possible with which on one hand objects can be processed and/or sorted that are not suitable to be placed on a single first or second tray, but which are, because of their dimension, suitable to be placed both on a first and second tray, and with which on the other hand objects can be sorted that are suitable to be placed on a single first and/or second tray and which require guidance with pushing off the tray, wherein the guidance is provided by the first respectively second upright edge section.

In one embodiment, the drive system comprises a driving element of a first type wherein a first and a second tray are connected to the driving element, and wherein the drive system comprises a driving element of a second type wherein at the most one tray is connected to the driving element. As a result, it becomes possible to provide a device wherein at least one driving element is present to which a first or a second tray is connected and/or wherein at least one driving element is present to which both a first and a second tray are connected, so that objects which are too large for support by just a first or second tray, can still be offered to the device for processing and/or sorting by at least partially placing the object on the first tray, which is connected to the driving element, and at least partially on the second tray, which is connected to the driving element to which the first tray is connected.

In one embodiment, the width dimension of the slit is adjustable. As a result, it becomes possible to transport elongated objects which have a greatly varying cross-section, whereby the with dimension of the slit is adjustable to the cross-section of the object to be transported, in such a way that the object cannot fall through the slit and the zone extending underneath it.

In one embodiment, the first and/or second tray is/are provided with adjusting means for the at least partial bridging of the width dimension of the slit. As such, it becomes possible to decrease the width dimension of the slit before an elongated object, which is narrower than the width dimension of the slit, is placed on the support system and would otherwise fall through the zone extending underneath it.

In one embodiment, the adjusting means are formed by a filler that is attached to the first tray and/or the second tray that is respectively moveable to the second or first tray for filling of the slit. As such, it becomes possible that the elongated object, which is narrower than the width dimension of the slit, stays on the filler, as a result of which it is prevented that the object falls into the slit and the extending zone underneath it.

The invention will now be described in more detail by means of a few embodiments with reference to the figures. Within which:

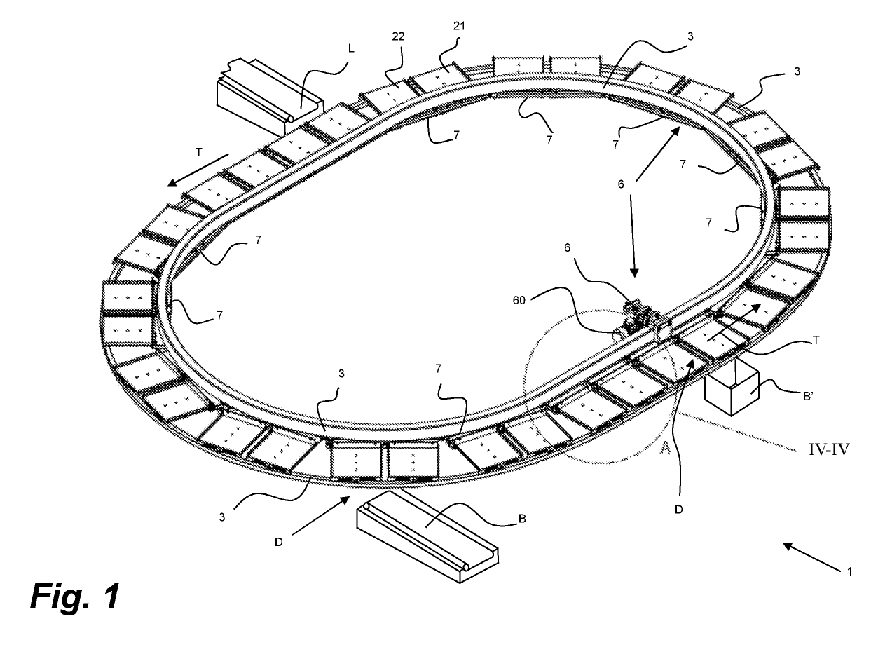

FIG. 1 is a perspective view of a device according to the invention, wherein multiple disposed trays that can be transported along a path are included that can be driven by means of a drive system that is arranged along the path;

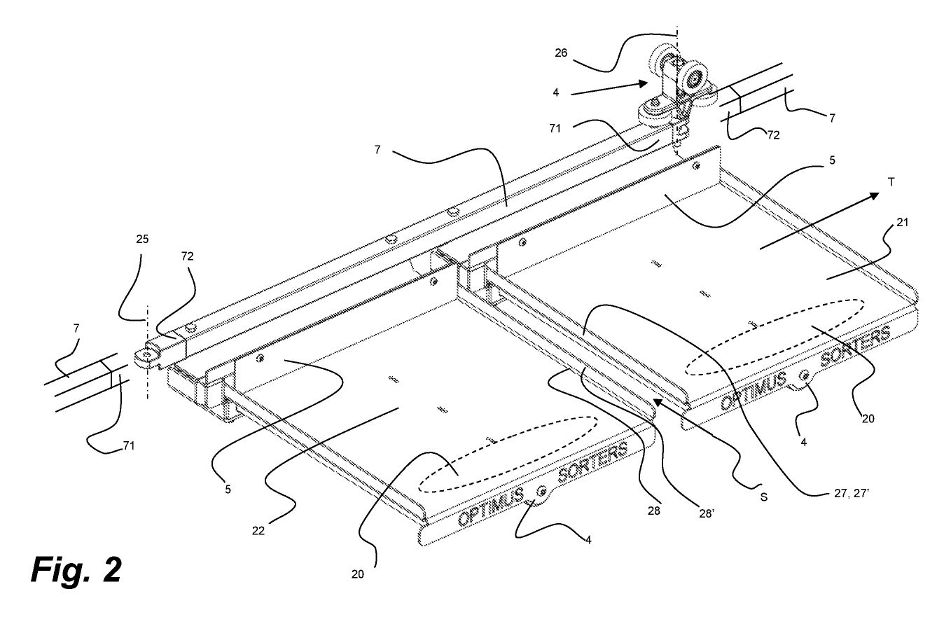

FIG. 2 is a perspective view of a first tray and a second tray which are each independently connected to the same driving element;

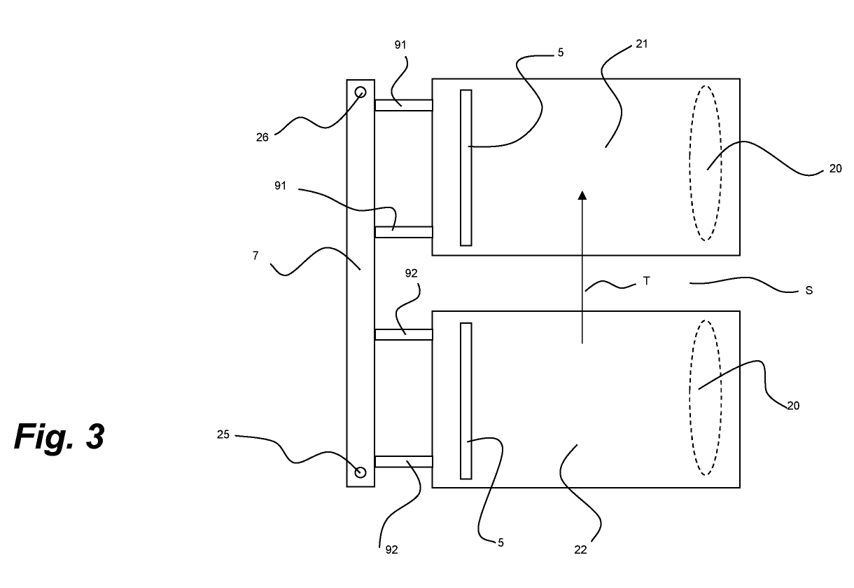

FIG. 3 is a schematic top view of the first tray and the second tray which are each independently connected to the same driving element;

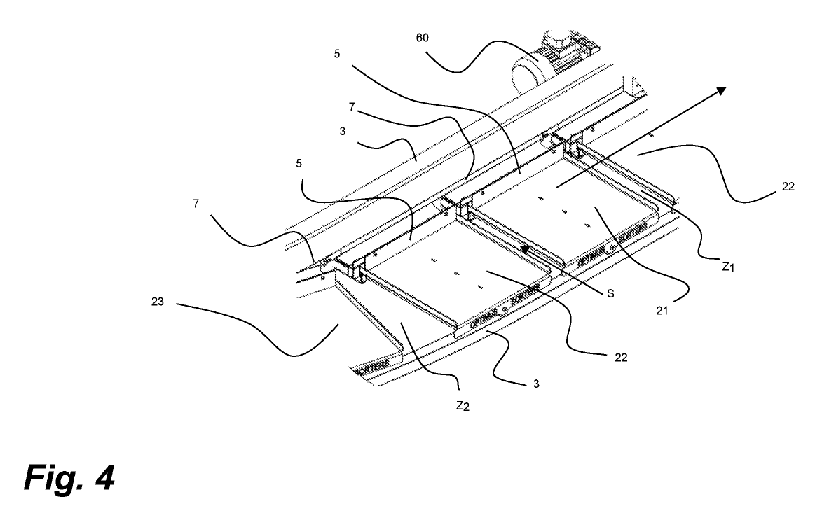

FIG. 4 is an enlargement from the perspective view of a portion circled with line IV-IV in FIG. 1.

In the figures, the same reference numerals denote identical components. FIG. 1 shows a device 1 according to the invention, in which the device 1 is arranged for the loading, conveying and discharging of goods or objects which are usually offered as single pieces at the location of a loading position L to the device 1 for the transport to a target position or discharge position D on the spot from which the object has to leave the device 1 in order to be included in a tray or container B placed next to the device 1 or a further conveyer B′ to a further target position, so that sorting is carried out to objects offered to the device 1.

For the support of the objects the device 1 is provided with multiple trays 21, 22 which are each intended for carrying an object in a transport direction T from the loading position L to the discharge position D. For the movement of the trays 21, 22, the trays 21, 22 are provided with guide elements 4 depicted in FIG. 2 and the device 1 is provided with guides 3 which form a path for the transport of the trays 21, 22.

The device 1 is intended for a substantially continuously working process, such as a sorting process, wherein the trays 21, 22 are transported via the path with a substantially constant speed. Partly for the benefit of the continuously working sorting process, the path is endless, i.e. the path generally forms a curved trajectory or a closed loop shown in FIG. 1 wherein the trays 21, 22 pass a same arbitrary point of the path multiple times during operation.

For driving the motion of the trays 21, 22 the device 1 is provided with a drive system 6 which extends substantially parallel to and at a distance from the path for the trays 21, 22 that are to be conveyed in the conveyance direction T from the loading position L to the discharge position D.

The drive system 6 comprises a series of linked driving elements 7 for the purpose of transporting the trays 21, 22 along the path, which are transportable along the path in the conveyance direction T. FIG. 2 shows that an end 72 of the driving element 7, rear-facing seen from the conveyance direction T, is pivotally connected around an axis 25, extending substantially transverse to the path, with an end 71 of the subsequent driving element 7 which is forward-facing seen from the conveyance direction T. An end 71 of the driving element 7 which is forward-facing seen from the conveyance direction T is pivotally connected, around a substantially transverse to the path extending axis 26, to an end 72 of a preceding driving element 7 which is rear-facing from the conveyance direction.

For driving the drive system 6 a drive 60 shown in FIG. 1 is arranged for transferring a drive power onto the drive system 6, which drive power is required for conveying the trays 21, 22. In this example the drive 60 comprises an electric motor which transfers the drive power to the driving elements 7 via, for example, a driving wheel, connected to an end shaft of the electric motor, which, pressing and/or clamping against at least one of the drive elements 7, is capable to transfer the driving power by means of friction or traction.

For controlling at least the drive 60 for the purpose of movement of the drive system 6 in the conveyance direction T, a not shown control system is included in the device 1. Additionally de control system controls the positioning of an object to be sorted on a tray 21, 22 near the loading position. Thereby the control system is arranged for the determination of a moment at which an object can be placed on a tray 21, 22 so that the object preferably ends up in the middle of a tray 21, 22.

For the discharging of an object present on a tray 21, 22 a pushing arm 5 is provided on the tray 21, 22, as is shown in FIG. 2, for the discharging of an object present on the tray 21, 22 by means of pushing away. The pushing arm 5 is arranged such on the tray 21, 22 that the pushing away takes place substantially transverse to the conveyance direction T of the tray 21, 22. When the tray 21, 22 is in the discharge position an object is pushed away from the tray 21, 22 by means of the pushing arm 5, whereby the object leaves the tray 21, 22 via an unloading section 20 of the tray 21, 22.

The pushing arm 5 is situated, at least during conveyance of the objects present on one of the trays 21, 22, on a side facing away from the unloading section 20 of the tray 21, 22, in a first position. The pushing arm 5 is arranged on the tray 21, 22 in such a way that the pushing arm, at least to the purpose of discharging an object present on one of the trays 21, 22, moves to a second position wherein which the pushing arm 5 is situated near the unloading section 20 of the tray 21, 22.

Underneath the path of the trays 21, 22 the device 1 is provided with a not shown exchange system for driving the pushing away, in a direction substantially transverse to the conveyance direction T, of an object present on the tray 21, 22. in order to equip a space underneath the path of the trays 21, 22 with components for the benefit of the exchange system, a driving element 7, seen in a cross section transverse to the conveyance direction T is positioned substantially in such a way with respect to the tray 21, 22 that a part of the tray 21, 22 facing away from the unloading section 20 is situated between the unloading section 20 of the tray 21, 22 and the driving element 7. As a result, the drive system 6 is situated substantially lateral with respect to the path of the trays 21, 22, so that underneath the path of the trays 21, 22 a space is available for other components needed for the device, such as the exchange system.

The exchange system comprises an actuator which is fixedly connected relative to the path which is arranged to cooperate with a pushing arm 5 arranged on the tray 21, 22 when in operation, to which a protrusion is connected which extends towards the exchange system. When operating the actuator, a movable part of the actuator ends up in the path of the protrusion, in such a way that the actuator contacts the protrusion and urges the protrusion in a guiding part of the exchange system, which is inclined with respect to the conveyance direction T, so that during the conveyance of trays 21, 22 the pushing arm 5 moves from the first position to the second position.

The control system is adapted for an operation of the actuator for the purpose of a movement of the pushing arm 5 of the first tray 21 and for a subsequent operation of the actuator with the purpose of a movement of the pushing arm 5 of the second tray 22. An independent operation of the actuators generates an independent movement of the pushing arm 5, so that for example an object placed on the first tray 21 can be discharged before an object placed on the second tray 22 which is connected to the same driving element 7.

FIG. 2 shows a pair of trays 21, 22, wherein, seen from the conveyance direction T, a first tray 21 precedes with respect to a subsequent second tray 22. The first tray 21 is fixedly connected to a driving element 7 and the second tray 22 is fixedly connected to the driving element 7 to which the first tray 21 is fixedly connected. In other words, the first tray 21 and the second tray 22 are each independently rigidly connected or both translation-fixedly and rotation-fixedly connected to the same driving element 7. This is schematically shown in FIG. 3.

In particular, according the invention, the first tray 21 is translation-fixedly and rotation-fixedly connected to the driving element 7 by means of first connection means 91 and the second tray 22 is translation-fixedly and rotation-fixedly connected to the driving element 7 by means of connection means 92, in such a way that during the conveyance of the trays 21, 22 there is substantially no difference in displacement, such as a difference in translation and rotation, of the first tray 21 with respect to the driving element 7 and there is substantially no difference in displacement, such as a difference in translation and rotation, of the first tray 22 with respect to the driving element 7. As a result, the first tray 21 is rigidly connected to the driving element 7 and the second tray 22 is rigidly connected to the driving element 7 to which the first tray 21 is connected. Only dynamic effects where, for example, the trays 21, 22 move shockingly along the path, such as in a bend, can cause slight mutual differences in displacement.

Between the first tray 21 and the second tray 22 a slit S extends which is free of parts for this example. Underneath the path of the device 1 a, not shown, detection device connected with the control system can be present for detecting an object that is placed on the first tray 21, which at least partially hangs over a rearward edge 27, seen from the conveyance direction T, of the first tray 21 and/or for the detecting of an object placed on the second tray 22, which at least partially hangs over a forward edge 28, seen from the conveyance direction T, of the first tray 22. Objects which partially hang over an edge of a tray 21, 22 can endanger the continuous operation in which such devices 1 are used.

In particular, an object can be offered to the device 1 for processing, such as sorting, the object having such a dimension that it at least partially has to be placed on the first tray 21, and at least partially on the second tray 22 which is connected to the first tray 21 via the driving element 7. Such an object deviates from the objects that are suitable to be processed with a single tray 21, 22. Relating to the pursuit of a continuous operation, the device 1 has a strong preference to guard a deviating object during processing. As soon as this deviating object passes said detection means and is detected by the detecting means, a signal is sent by the detection means to the control system as a confirmation that the object is still situated partially on the first and partially on the second tray 21, 22. As soon as the detection means detects that the deviating object has, for example, dropped deeper into the slit S than is acceptable, or that the deviating object could constitute a danger to the continuous operation in another way, the detection means sends a signal to the control system to stop the operation and/or to issue an alarm signal to an operator of the device 1.

For the discharging of a deviating object the control system is adapted for an operation of the actuator for the purpose of a movement of the pushing arm 5 of the first tray 21 and substantially simultaneous operation of the actuation for the purpose of a movement of the pushing arm 5 of the second tray 22.

For the discharging of a non-deviating object, which object has such dimensions and/or such a weight that it can be processed by the device 1 as a single piece in a single tray 21, 22, an edge adjacent to the slit S, of both the first and second tray 21, 22, is provided with a upright edge section 27′, 28′ for a directed guidance of the object during the pushing off the tray, in a substantially transverse direction to the conveyance direction T.

The device 1 according to the invention is specifically meant for the transportation and sorting of objects that are elongated and which, for example, are substantially cylindrical in shape. During operation of the device 1, an elongated cylindrical object that is placed on the tray, with its circumferential wall laying or resting on the tray, tends to roll of the tray as a result of the dynamic operation of the device 1. As a result, objects rolling of the tray unintentionally end up in a tray or container B placed next to the device 1 or on a further transporter B′. The device 1 according to the invention provides a support system that is formed by edge sections 27, 28 of the respective first and second tray 21, 22, the edge sections extending on either side of the slit S. On the edge sections 27, 28 the elongated object is placeable whereby the object, during dynamic operation of the device 1, can no longer roll of the tray.

In FIG. 2 the pushing arm 5 is shown, whereby the pusher arm 5 of at least the first tray 21 is provided with an end that reaches beyond the edge 27 and that reaches in the slit S. The over the edge 27 and into the slit S reaching end of the pusher arm 5 is provided with a concentrated mass. As a result, a balanced drive of the pusher arm 5 between the first and second position becomes possible, whereby an object to be transported that is placed above and/or in the slit S can be pushed of the tray 21.

FIG. 4 shows a part of the device 1 according to the invention, the device being circled in FIG. 1, wherein, by energization of the electric motor 60, a substantially continuous movement of the first and second trays 21, 22 in the conveyance direction T along the guides 3 is possible via driving elements 7. In the opposite direction of the conveyance direction T a driving element 7 is visible to which subsequently a first tray 21 and a second tray 22 is connected. Further in the opposite direction to the conveyance direction T a part of a further driving element 7 is visible to which a further tray 23 is connected. As such, the device 1 can be equipped with driving elements 7 of a first type wherein a first and second tray are connected to the driving element, and with driving elements of a second type wherein the driving element is connected with a maximum of one tray. In this manner, a mixed sorting device becomes possible wherein driving elements are included to which only one tray is connected and wherein driving elements 7 are included to which two trays 21, 22 are connected. Such a device 1 is thus flexible in capacity for processing of both smaller objects and larger and/or heavier objects.

In summary, according to the invention a device is provided for loading, conveying and discharging of objects, which device is provided with:

trays each intended for carrying an object from a loading position to a discharge position,

a pusher arm arranged on the tray for by means of pushing away, discharging an object present on the tray,

a drive system for conveying the trays in a conveyance direction from the loading position to the discharge position, wherein for the purpose of conveying the trays along a path, the drive system comprises a series of linked driving elements, and

a drive for driving the drive system, wherein, seen form the conveyance direction, a first tray precedes with respect to a subsequent second tray, wherein the first tray is fixedly connected with one of the driving elements, and wherein the second tray is fixedly connected to the driving element to which the first tray is connected. As such, a device, which is provided with trays and pusher arms arranged on the trays, becomes possible wherein, with a movement of the trays, both on a straight part and on a bend, a gap present between the first tray and the second tray remains constant and wherein the first and second trays do not move apart, whereby the risk that an object partially present on the first tray and partially present on the second tray can fall in the resulting gap between the first and second tray is substantially eliminated and a disturbance of the conveyance process, such as a halt of the sorting device, is substantially prevented.

The invention is naturally not limited to the described and shown preferred embodiment, but extends to any embodiment which falls within the scope of protection as defined by the claims and seen in the light of foregoing description and accompanying drawings.

1. A device for loading, conveying and discharging objects, which device is provided with:
trays each intended for carrying an object from a loading position to a discharge position, in which discharge position the object leaves the tray via an unloading section of the tray,
a drive system for conveying the trays in a conveyance direction from the loading position to the discharge position, wherein for the purpose of conveying the trays along a path, the drive system comprises a series of linked driving elements,
a drive for transferring a drive power onto the drive system, which drive power is required for conveying the trays, and
a pusher arm arranged on the tray for by means of pushing away, discharging an object present on the tray, wherein pushing away takes place substantially transverse to the conveyance direction of the tray and wherein at least during conveyance of an object present on the tray the pusher arm is in a first position facing away from the unloading section, and wherein at least for discharging an object present on the tray, the pusher arm moves to a second position in which the pusher arm is near the unloading section of the tray, and
wherein considered in the conveyance direction a first tray precedes a subsequent second tray, wherein the first tray is fixedly connected to one of the driving elements, and wherein the second tray is fixedly connected to the driving element to which the first tray is fixedly connected,
wherein a slit extends between an edge of the first tray which extends near the second tray and an edge of the second tray which extends near the first tray, wherein a width dimension of the slit is selected such that the edges form a supporting system for supporting, during transportation, the circumferential wall of elongated objects with a cross section of at least 12.5 mm.

2. The device according to claim 1, wherein the width dimension of the slit is in the range of 10-100 mm, preferably in the range of 15-50 mm, with even more preference in the range of 20-30 mm.

3. The device according to claim 1, wherein the pusher arm of the at least one tray is provided with an end that reaches over the edge and reaches, at least partially, above the slit for the unloading, by means of pushing away, an object that is present on the supporting system.

4. The device according to claim 1, wherein considered in cross-section oriented transverse to the conveyance direction, a driving element is arranged substantially such relative to the tray that a part of the tray facing away from the unloading section is situated between the unloading section of the tray and the driving element.

5. The device according to claim 1, comprising a control system for controlling at least the drive for the drive system and for positioning an object to be sorted on a tray, wherein the control system is adapted for determining a moment of placing an object of such dimensions that it has to be placed at least in part on the first tray, and at least in part on the second tray that is connected to the first tray via the driving element.

6. The device according to claim 1, comprising an exchange system placed underneath the path of the trays, for driving the pusher arm in order to push away an object present on the tray substantially transverse to the conveyance direction.

7. The device according to claim 6, wherein the exchange system comprises an actuator and the pusher arm arranged on the tray comprises a protrusion extending towards the exchange system, wherein the actuator, when operated, ends up in the path of the protrusion such that the actuator contacts the protrusion and urges the protrusion in a guiding part of the exchange system as a result of which the pusher arm moves into the second position.

8. The device according to claim 7, wherein the control system is adapted for operating the actuator for a movement of the pusher arm of the first tray and for subsequent operation of the actuator for a movement of the pusher arm of the second tray.

9. The device according to claim 7, wherein the control system is adapted for operating the actuator for a movement of the pusher arm of the first tray and for substantial simultaneous operation of the actuator for a movement of the pusher arm of the second tray.

10. The device according to claim 7, wherein an edge of the first tray extending near the second tray is provided with a first upright edge section for during discharge guiding an object present on the first tray, and/or wherein an edge of the second tray extending near the first tray is provided with a second upright edge section for during discharge guiding an object present on the second tray.

11. The device according to claim 1, wherein the drive system comprises a driving element of a first type wherein a first and a second tray are connected to the driving element, and wherein the drive system comprises a driving element of a second type wherein at the most one tray is connected to the driving element.

12. The device according to claim 1, wherein the width dimension of the slit is adjustable.

13. The device according to claim 1, wherein the first tray and/or the second tray is/are provided with adjusting means for the at least partial bridging of the width dimension of the slit.

14. The device according to claim 13, wherein the adjusting means are formed by a filler, that is attached to the first tray and/or second tray, which is moveable towards the second tray or first tray respectively for the filling of the slit.
